(19) United States
(12) Patent Application Publication
(10) Pub. No.: US 2026/0352073 A1
(43) Pub. Date: Nov. 5, 2026

(54) Apparatus And Method For Flaring The Ends Of Flat Wire Conductors Projecting From One End Of A Motor Stator

(71) Applicant: Comau (Shanghai) Engineering Co., Ltd., Shanghai (CN)

(72) Inventors: Yunhui Gao, Shanghai (CN); Lei Suo, Shanghai (CN)

(21) Appl. No.: 19/486,248

(22) PCT Filed: May 17, 2024
(86) PCT No.: PCT/CN2024/093887

§ 371 Date: Nov. 20, 2025

(30) Foreign Application Priority Data
May 22, 2023 (CN) 202310581869.9

(51) Int. Cl. H02K 15/0643; B21F 5/00

(52) U.S. Cl. CPC H02K 15/0643; B21F 5/005

(57) ABSTRACT

An apparatus for flaring the ends of flat wire conductors, projecting axially outwardly from one end of a motor stator. A flaring device carried by a vertically movable support structure is vertically movable below a stationary top plate on which a motor stator is received. The flaring device includes a circumferential array of radially movable radial retractor elements for engaging respective ends of the flat wire conductors to retract and radially space them away from adjacent flat wire conductor ends. An insulating sheet protection device carried by the stationary top plate includes a circumferential array of radially movable radial protector elements for engaging respective sheet portions of insulating material preventing damage to the insulating material while the flat wire conductor ends are being retracted and spaced by the radial retractor elements of the flaring device.

### CROSS REFERENCE TO RELATED APPLICATION(S)

This application is filed pursuant to 35 U.S.C. § 371 claiming priority benefit to PCT/CN2024/093887 filed May 17, 2024, which claims priority benefit to China Patent Application No. 202310581869.9 filed May 22, 2023, the contents of both applications are incorporated herein by reference in their entirety for all purposes.

### TECHNICAL FIELD

The present invention relates to an apparatus for flaring the ends of flat wire conductors projecting axially outwardly from one end of a motor stator.

### BACKGROUND

With the development of the automotive industry in the field of vehicles with new propulsion systems, the market demand for electric and hybrid vehicles is greatly increasing. An electric propulsion system, as a component of an electric or hybrid vehicle, has a significant impact on power, economic efficiency, comfort, safety and service life of the vehicle. As a core of the electric propulsion system, the performance of an electric motor directly determines the performance of the vehicle to a great extent. Electric motors with stator windings formed by a plurality of flat wire hairpins have proved to be particularly advantageous. Groups of flat wire hairpins, each including two substantially parallel legs connected by a bridge portion, are introduced into the slots of a stator. The legs of the hairpins project axially outwardly from one end of the stator. Each slot receives a number of legs of different hairpins. The ends of the hairpin legs projecting axially upwardly from one end of the stator are initially located in positions closely adjacent to each other and need to be subjected to a so-called “flaring” operation, by which the different ends of the legs projecting from a same stator slot must be spaced away from each other, to enable the spaced ends to be subjected to the subsequent processing operations.

An example of an apparatus for flaring the ends of flat wire conductors projecting axially outwardly from one end of a motor stator is known, from document WO 2020/127718 A1.

Studies and tests conducted by the Applicant have shown that the prior solutions in this field are not completely satisfactory. One problem which has been encountered lies in that the flat wire conductors are inserted within the inner slots of the stator with the interposition of sheets of insulating material, typically insulating paper. When performing the flaring operation to space the conductor ends away from each other, it may happen that the insulating sheets can become damaged or torn.

### SUMMARY

There is therefore a need for an apparatus which is able to perform the flaring operation in an efficient and fast way, but which at the same time ensures a product of high quality to be obtained, without a risk of damage of the insulating sheets within the slots of the motor stator.

It is therefore an object of the present invention to provide an apparatus for flaring the ends of flat wire conductors projecting axially outwardly from one end of the motor stator, which enables the projecting conductor ends to be spaced away from each other, while avoiding any damage to the insulating sheets which are housed within the stator slots, between the flat wire conductors and the stator wall.

It is another object of the invention to achieve the above indicated purpose by an apparatus which is efficient in operation and which enables a high productivity with a high quality of the finished product.

Still another aim of the invention is to achieve the above indicated objectives with an apparatus which is relatively simple and reliable and which enables easy and quick maintenance operations.

In view of achieving one or more of the above indicated objects, the invention provides an apparatus for flaring the ends of flat wire conductors projecting axially outwardly from one end of a motor stator, said apparatus comprising:
a stationary support frame, configured for receiving and supporting a motor stator having a plurality of flat wire conductors inserted within inner slots of the stator with the interposition of sheets of insulating material, said flat wire conductors having ends projecting axially outwardly from one end of the stator,
a vertically movable support structure, mounted on the stationary support frame,
a first driving device for controlling a vertical movement of the vertically movable support structure relative to the stationary support frame,
a flaring device carried by said vertically movable support structure and including a circumferential array of radially movable retractor radial elements configured for engaging respective ends of conductors projecting axially outwardly from the stator and for retracting the engaged ends radially outwardly, so as to space them away from adjacent conductor ends,
a second driving device for simultaneously controlling a radial movement of all the radial retractor elements of the flaring device between a radially inward position and a radially outward position,
an insulating sheet protection device carried by said stationary support structure and including a circumferential array of radially movable protector radial elements configured for engaging respective sheet portions of insulating material projecting axially outwardly from the stator, so as to prevent the engaged sheet portions of insulating material to become damaged while said conductor ends are being retracted by said retractor radial elements of the flaring device, and
a third driving device for simultaneously controlling a radial movement of all the protector radial elements of the insulating sheet protection device between a radially inward position and a radially outward position.

Due to the above indicated features, in the apparatus according to the invention, the insulating sheets projecting from the stator slots do not risk to become damaged as a result of the flaring operation of the projecting conductor ends, since the sheet portions projecting from the stator slots are held and protected in the proper configuration by being engaged by the radial protector elements of the insulating sheet protection device.

In a preferred embodiment, the flaring apparatus of the invention is further characterized in that:
said stationary support frame includes a top plate with a central aperture and configured to receive and support a stator with flat wire conductors and insulating sheets projecting axially outwardly from the stator,
said insulating sheet protection device being carried by said top plate, so that said circumferential array of radially movable protector radial elements surround the stator received within the central aperture of said top plate and are able to engage the sheet portions of insulating material projecting axially outwardly from the stator,
said third driving device for simultaneously controlling a radial movement of all the radial protector elements of the insulating sheet protection device including:
a driving annular plate, rotatably mounted on said top plate around a main axis of said central aperture of the top plate,
said driving annular plate having a plurality of spiral slits engaged by cam-followers which are carried by said protector radial elements, said spiral slits being configured so that a rotation of said driving annular plate between two end positions causes a radial movement of said protector radial elements between two end positions, and
an actuator for rotating said driving annular plate between said two end positions.

By using a driving annular plate with spiral slits, a simple and efficient way is obtained for simultaneously controlling the radial movement of the protector elements of the insulating sheet protection device. Each spiral slit can be designed according to an Archimedean spiral, to enable a constant speed radial movement of the protector elements.

In the abovementioned preferred embodiment, the driving annular plate is rotatably mounted on a stationary annular plate carried by said top plate and having a plurality of radial grooves within which the radial protector elements are slidably guided.

Preferably, each of the spiral slits is engaged by two cam-followers carried by two different radial protector elements, so that the number of spiral slits is half the number of the radial protector elements.

Also, in the preferred embodiment, each radial protector element has a radially inner end configured to be introduced between two insulating sheet portions projecting outwardly from two adjacent slots of the stator, so that each insulating sheet portion is engaged on two sides by two protector elements.

According to a further feature of the preferred embodiment, the flaring apparatus is further characterized in that:
said vertically movable support structure includes a vertically movable plate which is slidably mounted below said top plate on guiding columns rigidly connecting said top plate to a base frame forming part of said stationary support frame,
said flaring device being carried by said vertically movable plate, so that when the vertically movable plate is in a raised position, said circumferential array of radially movable retractor radial elements surround the stator received within the central aperture of said top plate and are able to engage respective ends of conductors projecting axially outwardly from the stator and to retract the engaged conductor ends radially outwardly, so as to space them away from adjacent conductor ends,
said second driving device for simultaneously controlling a radial movement of all the radial retractor elements of the flaring device (300) including:
a driving annular plate, rotatably mounted on said vertically movable plate around a main axis of said central aperture of the top plate,
said driving annular plate of the second driving device having a plurality of spiral slits engaged by cam-followers which are carried by said radial retractor elements, said spiral slits being configured so that a rotation of said driving annular plate between two end positions causes a radial movement of said radial retractor elements between two end positions, and
an actuator for rotating said driving annular plate of the second driving device between said two end positions.

In one example, said driving annular plate of the second driving device is rotatably mounted between a stationary lower annular plate carried by said vertically movable plate and a stationary upper annular plate having a plurality of radial grooves within which said radial retractor elements are slidably guided.

Preferably, each of the spiral slits is engaged by two cam-followers carried by two different radial retractor elements, so that the number of spiral slits of the driving annular plate of the flaring device is half the number of the radial retractor elements.

According to a further preferred feature, each radial retractor element includes a rod portion having a radially inner end with an upwardly projecting hollow hook portion defining a cavity within which one or more conductor ends can be received. Preferably, each radial retractor element includes the abovementioned rod portion and a support bar to which the rod portion is rigidly connected, in a radially adjustable position. This support bar is slidably guided within a respective groove of the supporting annular plate of the flaring device. Further, each support bar carries a cam-follower engaging a respective slit of the driving annular plate of the second driving device.

In one example, the first driving device for controlling the vertical movement of the vertically movable support structure includes a screw rigidly connected to the above-mentioned top plate and engaged through a nut which is rotatably carried by the stationary support frame and which is driven by an actuating motor through a belt transmission.

Furthermore, in the preferred example, the flaring apparatus includes a handling head movable relative to the stationary support frame at least along one vertical axis and along a horizontal axis and provided with a gripper for transferring a stator between a conveyor adjacent the flaring apparatus and the flaring apparatus.

The invention is also directed to a method implemented by the above-described apparatus, as set forth in claim 11.

### BRIEF DESCRIPTION OF THE DRAWINGS

Further features and advantages of the invention will become apparent from the following description with reference to the annexed drawings, given purely by way of non-limiting example, in which:

FIG. 1 is a diagrammatic perspective view of a flaring apparatus according to the invention,

FIG. 2 shows a cross-section in a vertical plane of a portion of the apparatus of FIG. 1,

FIG. 3 is another cross-sectional view of the same portion of the apparatus shown in FIG. 2,

FIG. 4 is a diagrammatic perspective view of an insulating sheet protection device forming part of the apparatus of FIG. 1,

FIG. 5 is a cross-section of the insulating sheet protection device of FIG. 4,

FIG. 6 is a diagrammatic perspective view of the flaring device forming part of the apparatus of FIG. 1,

FIG. 7 is an exploded perspective view of the flaring device of FIG. 6,

FIG. 8 shows the flaring device of FIG. 6 in a different operative condition,

FIG. 9 is a top view of the driving device for driving the movement of the retractor elements of the flaring device of FIGS. 6-8,

FIGS. 10-12 show perspective views of the flaring apparatus according to the invention, in three different operative conditions,

FIG. 13 is a perspective view at an enlarged scale of a motor stator engaged by a gripper carried by a handling head of the apparatus of FIGS. 10-12,

FIGS. 14, 15 are perspective view of the gripper of the handling head, in two different operative conditions,

FIG. 16 is another perspective view of the embodiment of FIGS. 10-12, showing a condition in which a stator has been unloaded on the flaring apparatus of the invention,

FIG. 17 shows a detail of FIG. 16 at an enlarged scale,

FIG. 18 shows the detail XVIII of FIG. 17 at an enlarged scale,

FIG. 19 is a perspective view of the insulating sheet protection device of the apparatus of FIG. 10,

FIG. 20 is an exploded perspective view of the insulating sheet protection device of FIG. 19,

FIG. 21 is a perspective view showing two protector elements forming part of the insulating sheet protection device,

FIG. 22 is a perspective view at an enlarged scale showing a detail of a number of protector elements in an inoperative position, spaced apart from the insulating sheet portions projecting from the slots of a stator,

FIG. 23 is another perspective view showing a number of protector elements in their inoperative positions,

FIG. 24 shows the same detail of FIG. 22, with the protector elements in their operative positions in engagement with the insulating sheet portions projecting from the stator slots,

FIG. 25 is a perspective view of the flaring apparatus of the invention,

FIGS. 26, 27 are side elevational view showing the flaring device in the lower position and in the raised position, respectively,

FIG. 28 is another perspective view showing the driving device for driving the vertical movement of the plate carrying the flaring device,

FIG. 29 is another perspective view of the flaring device,

FIG. 30 is a perspective exploded view of the flaring device of FIG. 29,

FIG. 31 is another perspective view at an enlarged scale of a portion of FIG. 30,

FIG. 32 is a perspective view at an enlarged scale of a single retractor element forming part of the flaring device of the invention,

FIG. 33 is a perspective view of a component of the unit of FIG. 32,

FIG. 34 is another perspective view showing one retractor element in engagement with two conductor ends projecting outwardly from a stator, and

FIG. 35 diagrammatically shows, in a side view, different steps of the flaring operation.

### DETAILED DESCRIPTION

In the drawings, reference 1 generally designates an apparatus for flaring the ends of flat wire conductors projecting axially outwardly from one end of a motor stator.

As indicated, in the present description and in the appended claims, the term “flaring” is used to indicate the operation by which the different ends of the conductors projecting from a same stator slot must be spaced away from each other, to enable the spaced ends to be subjected to the subsequent processing operations.

Also, in this description and in the claims, reference is made to “flat wire” conductors, i.e., conductors having a substantially flat, non-circular, cross-section. However, nothing excludes that the same invention can be applied to conductors of any other known type.

Referring to the drawings, apparatus 1 includes a stationary support frame 100, which comprises a base plate 101 and a top plate 109 which, is rigidly connected to the base plate 101 by four columns 102, so that top plate 109 is in an elevated position, spaced apart upwardly from the base plate 101. The top plate 109 has a central aperture 109A, whose axis is designated by A, within which a stator S can be received and supported, as shown in detail in the following.

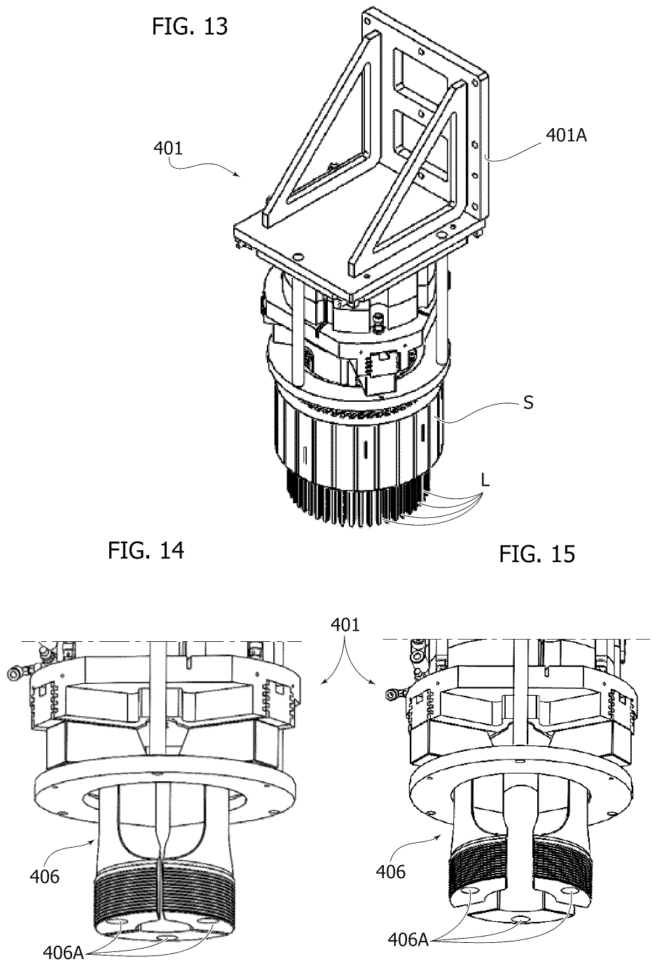

The apparatus is configured for receiving a stator S with flat wire conductors L inserted within the inner slots of the stator and having ends projecting axially outwardly from the lower end of stator S (see in particular FIGS. 13 and 26). The flat wire conductors inserted within the inner slots of the motor stator include the interposition of insulating material.

In the preferred example, the flat wire conductors are in the form of a plurality of hairpins, each having two substantially parallel legs connected to each other by a bridge portion B. The stator S is received in the flaring apparatus 1 with the bridge portions B (see FIG. 19) projecting outwardly from an upper end of the stator and the legs projecting axially outwardly from a lower end of stator S, as shown in FIG. 26.

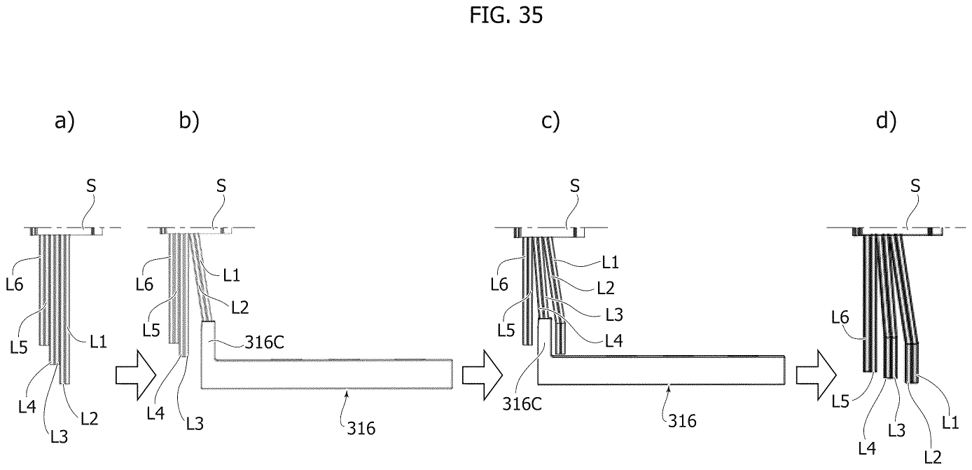

When the stator S is received in the flaring apparatus 1 of the invention, the conductor ends projecting from each slot of the stator are in positions closely adjacent to each other (as illustrated, for example, in FIG. 35(a). This FIG. refers to an example in which three pairs of flat wire conductors L1, L2; L3, L4; L5, L6 project axially downwardly from each slot of stator S. As shown in FIG. 35(a) the three pairs of conductors have three different projecting length. The first pair of conductors L1, L2 has the greatest projecting length. A second pair of conductors L3, LA have a medium-size projecting length, while a third pair of conductors L5, L6 have the shortest projecting length. It is to be understood however, that the arrangement shown in FIG. 35 is just an example and that the numbers and configurations of the conductors L received within each slot of the stator could be different.

In the case of the illustrated example, the flaring operation which is carried out by the apparatus according to the invention results in the arrangement shown in FIG. 35(d), in which the three pairs of conductors L1, L2; L3, L4, and L5, L6 have been spaced away from each other, so that they are in a proper position to be subjected to the subsequent processing operations for completing the stator manufacture.

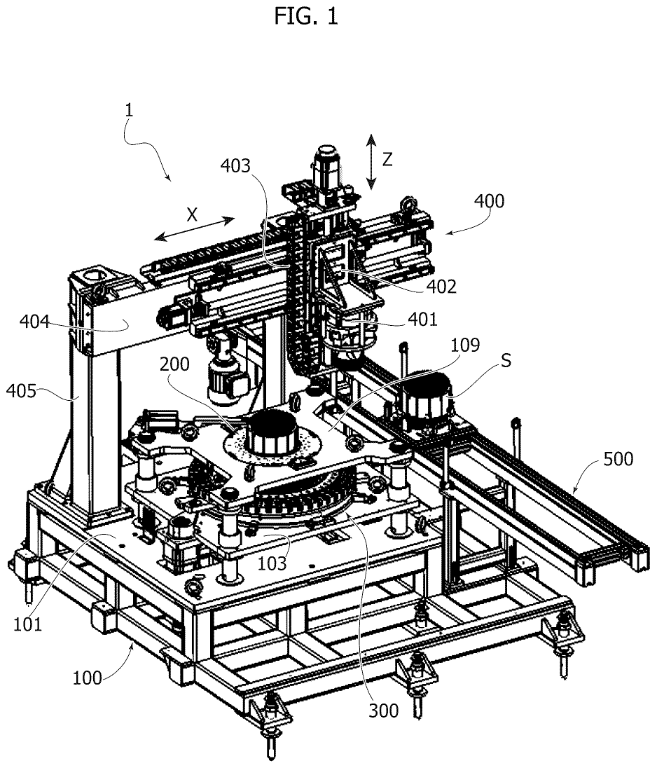

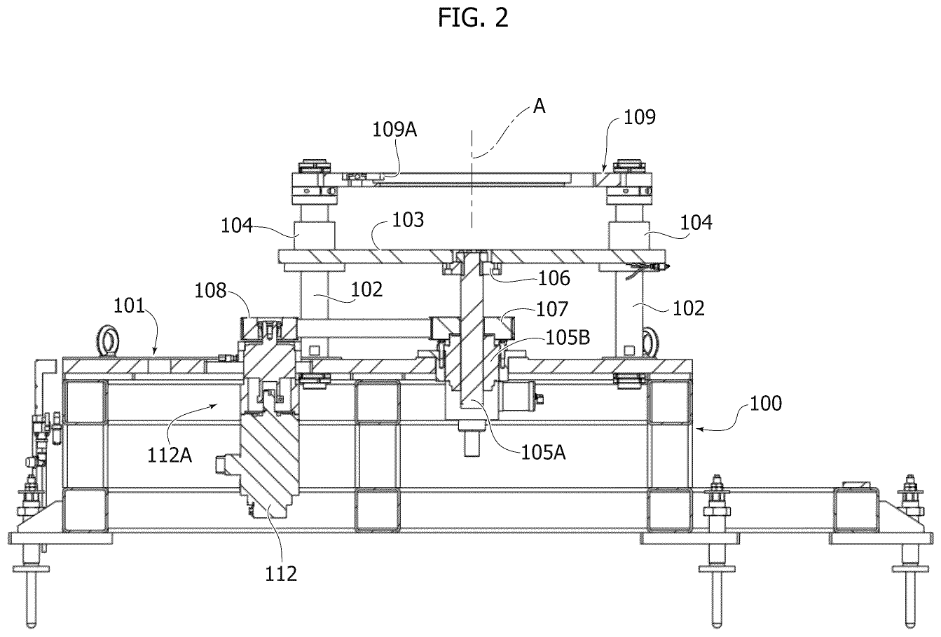

In order to perform the above-described flaring operation, the apparatus 1 of the invention includes a flaring device 300 (FIG. 1) carried by a vertically movable plate 103 (FIG. 2) which is slidably guided on the columns 102. For this purpose, the vertically movable plate 103 carries four bush bearings 104 which are slidably mounted around guide columns 102. In one example, the vertically movable plate 103 is slidably mounted below said top plate 109 on the guiding columns 102 rigidly connecting said top plate 109 to a base frame forming part of the stationary support frame 100.

The apparatus 1 includes a first driving device 112A for controlling the vertical movement of plate 103. With reference particularly to FIGS. 2 and 28, the first driving device 112A includes a servo-controlled electric motor 112 which drives rotation of a nut 105B (FIG. 2), which is rotatably supported by the base plate 101 of the stationary support frame 100. In this example, the motor 112 drives the rotation of nut 105B through a belt transmission including a belt engaged on a pulley 108 driven by the motor 112 and a pulley 107 connected to the nut 105B. The nut 105B is engaged by a vertical screw 105A whose upper end is connected to the vertically movable plate 103 through a bushing 106. Due to this arrangement, activation of electric motor 112 causes a rotation of the nut 105B, which results into a vertical movement of the screw 105A, since the screw is prevented from rotating by being rigidly connected to the plate 103. Naturally, the vertical movement of the movable plate 103 could be controlled in any other way, by any other known means. The servo-controlled electric motor 112 is controlled by an electronic controller of the apparatus in order to displace the movable plate 103 vertically in the various steps of the method according to the invention, as will be described in detail in the following.

The flaring device 300 carried by the vertically movable plate 103 will be described in detail hereinafter.

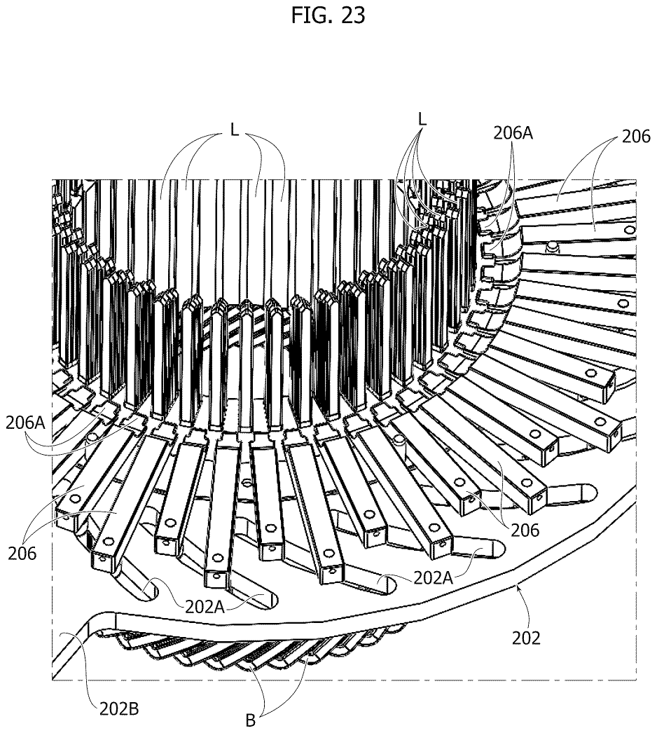

Reverting to FIG. 1, apparatus 1 further comprises an insulating sheet protection device 200 carried by the top plate 109, which has the function of protecting, during the flaring operation, the sheets of insulating material (paper in this example) which are interposed, within the stator slots, between the flat wire conductors and the stator wall, so that these insulating sheets cannot become damaged as a result of the flaring operation. With reference for example to FIG. 22, which shows a detail of a lower end of the stator (shown upside-down), sheets P of insulating paper are inserted within the slots of the stator S, each sheet P being interposed between the conductors L and the wall of the stator slots. Each insulating sheet P has a portion projecting outwardly from the respective stator slot and this sheet portion runs the risk to be damaged during the flaring operation by which the conductors L are spaced away from each other. In order to prevent any possible damage of the insulating sheets P, the apparatus 1 according to the invention includes the insulating sheet protection device 200, which will be described in detail in the following.

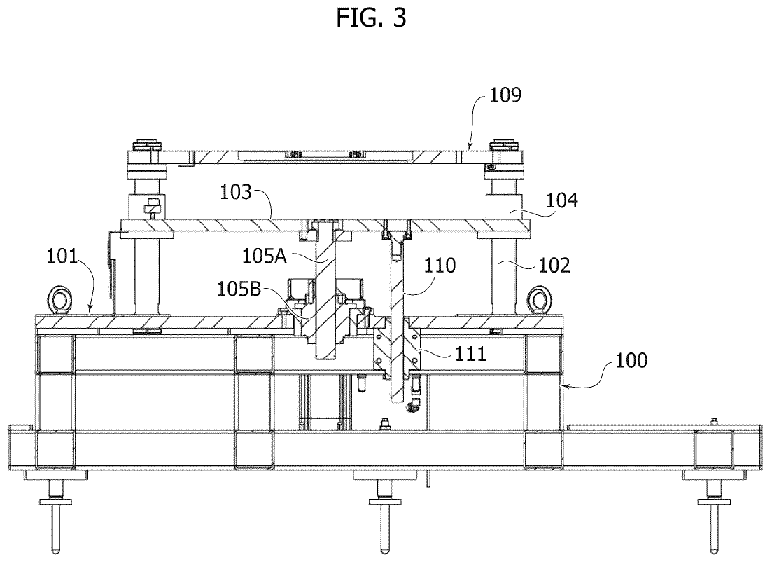

FIG. 3 shows an embodiment in which the movable plate 103 also carries a vertical rod 110 which is slidably guided within the base plate 101 and can be locked in position with the aid of a locking cylinder 111.

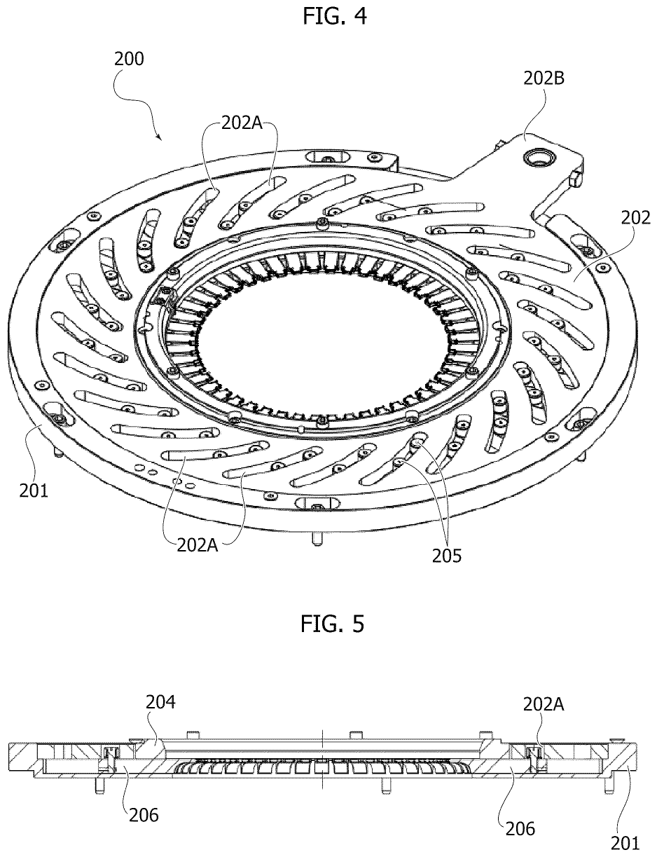

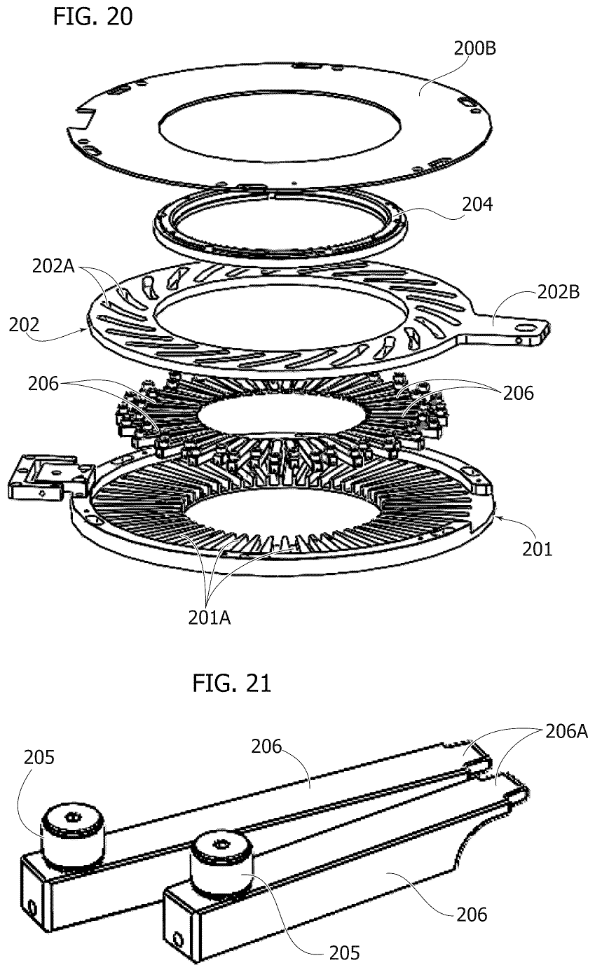

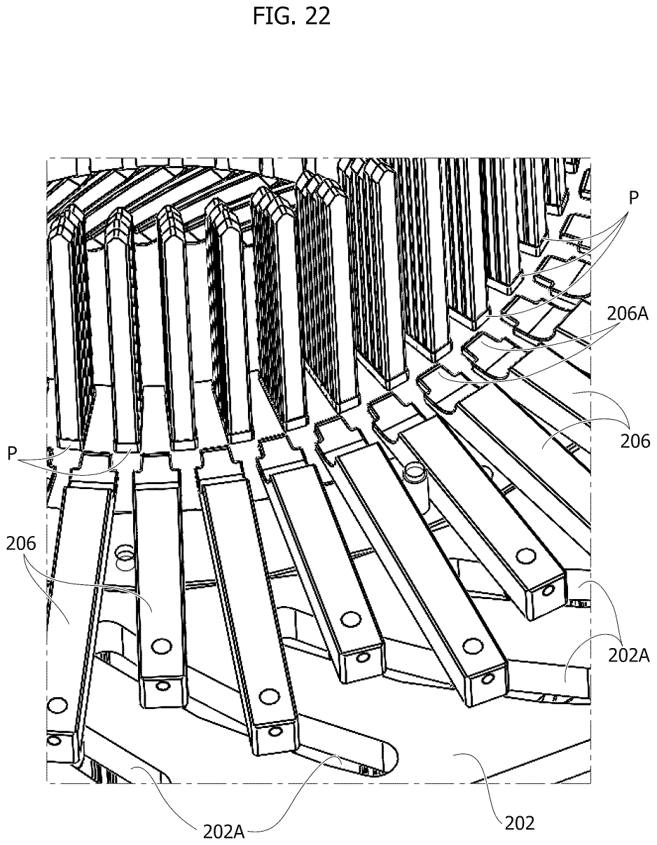

FIGS. 4, 5 and 20 show an example of the insulating sheet protection device 200 of the apparatus according to the invention. The insulating sheet protection device 200 includes a stationary annular plate 201 which is mounted on the top plate 109, coaxially with the central aperture 109A. As better shown in FIG. 20, the stationary annular plate 201 has an upper surface in which a circumferential array of radial grooves 201A are formed. The grooves 201A slidably receive radial protector elements 206, two of which are shown, at an enlarged scale, in FIG. 21. The radially movable radial protector elements 206 surround the motor stator(S) received within the central aperture 109A of the top plate 109 and are able to engage the sheet portions (P) of the insulating material projecting axially outwardly from the motor stator(S). Radial protector elements 206 are alternatively of two different lengths, as shown in FIG. 21, for reasons which will become clear in the following. Each protector element 206 has a radially inner end configured to be introduced between two insulating sheet portions (P) projecting outwardly from two adjacent slots of the motor stator so that each insulating sheet portion is engaged on two sides by two radial protector elements 206. Each radially inner end forming a tooth portion 206A, configured for being engaged between two sheet portions P projecting from two different stator slots, as shown in FIG. 24.

The radial movement of the radial protector elements 206 is controlled by a driving annular plate 202 which is rotatably mounted within a raised peripheral edge of the stationary annular plate 201. The driving annular plate 202 is formed with a plurality of spiral slits 202A within which cam-followers 205 are engaged, in the form of freely rotatable rollers, each roller 205 being carried by a respective protector element 206.

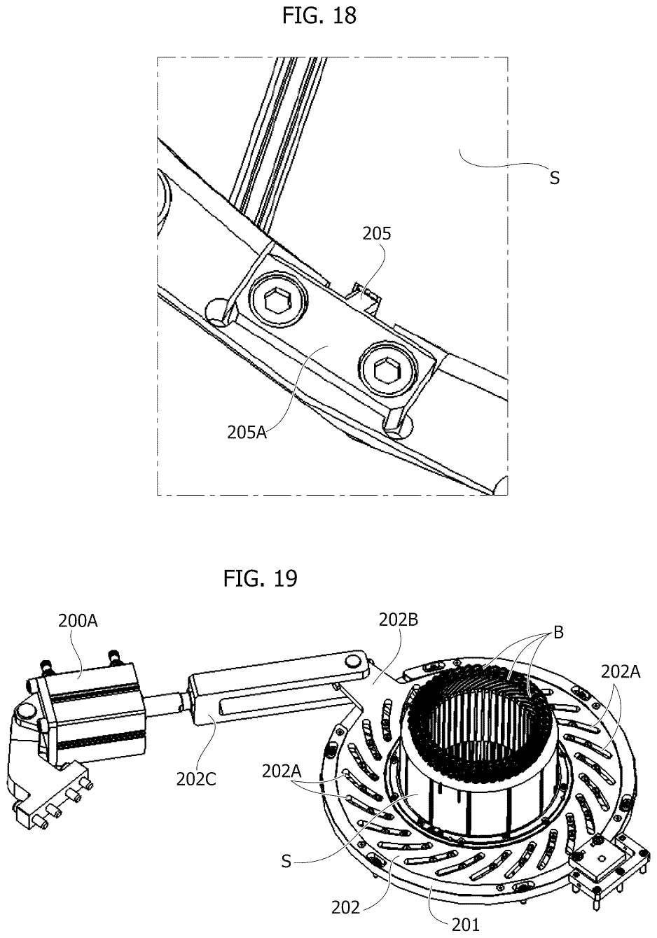

In the present embodiment, each spiral slit 202A is engaged by two rollers 205 of two different protector elements 206. In this manner, the number of the spiral slits 202A can be half the number of the protector elements 206. For this reason, each spiral slit 202A is engaged by two protector elements 206 having different lengths. A positioning ring 204 is mounted around a central aperture of the driving annular plate 202 and carries a positioning key 205 which has a base plate 205A (FIG. 18) secured to ring 204, the positioning key 205 being configured for engaging a notch in the outer wall of the stator S (see FIG. 18) to correctly position the stator relative to the apparatus 1.

Referring to FIGS. 19, 20, the driving annular plate 202 has an outer radial projection 202B which is connected by a linkage 202C to an electric actuator 200A (FIG. 19).

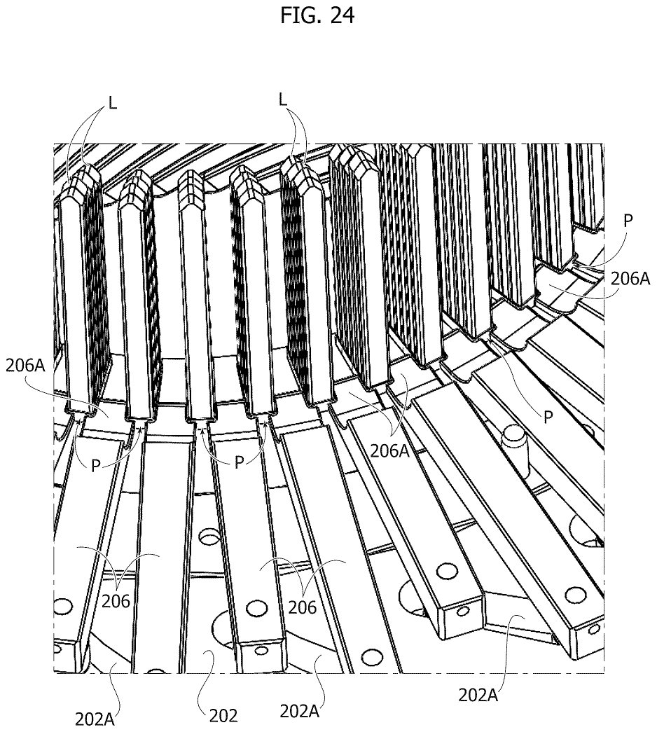

When the stator S is received within the positioning ring 204 of the insulating sheet protection device 200, the electric actuator 200A can be activated for moving the radial protector elements 206 from their radially outer positions, shown in FIGS. 22, 23, to their radially inner positions shown in FIG. 24, in which the tooth end portions 206A of the protection elements 206 are engaged between the sheet portions P projecting from the stator slots. Again, in FIGS. 23-25, the stator is shown in an upside-down position in order to show the lower end of the stator from which the conductor ends project.

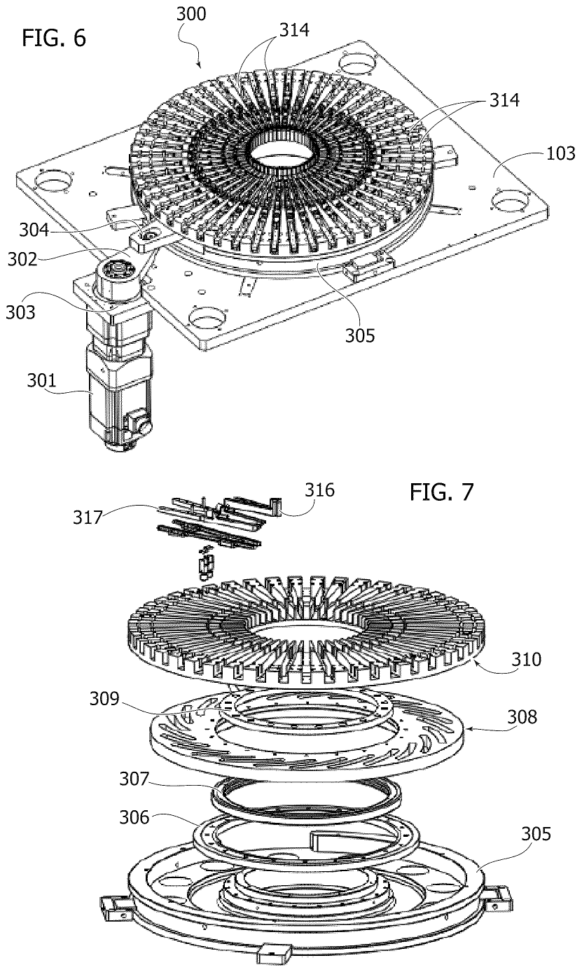

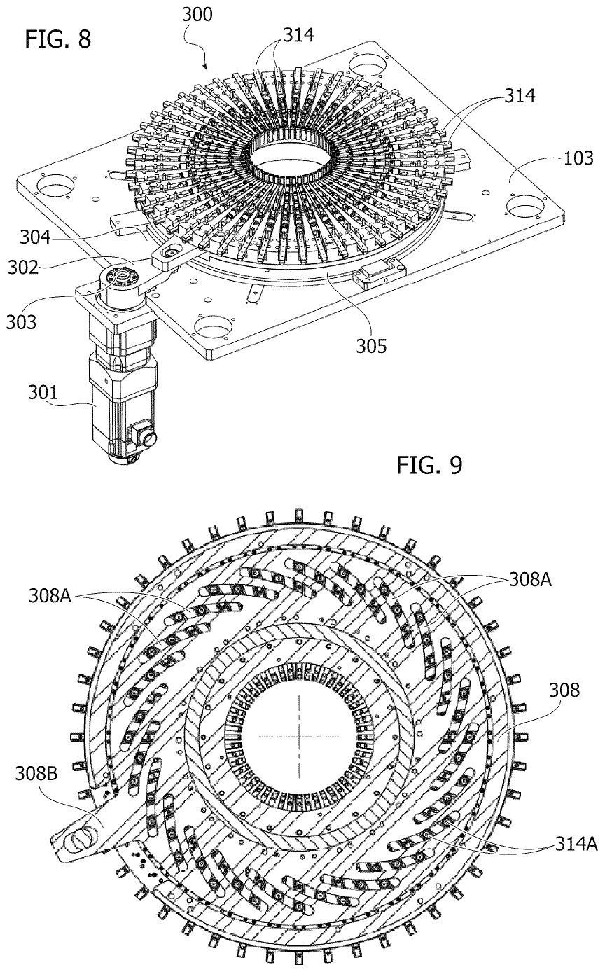

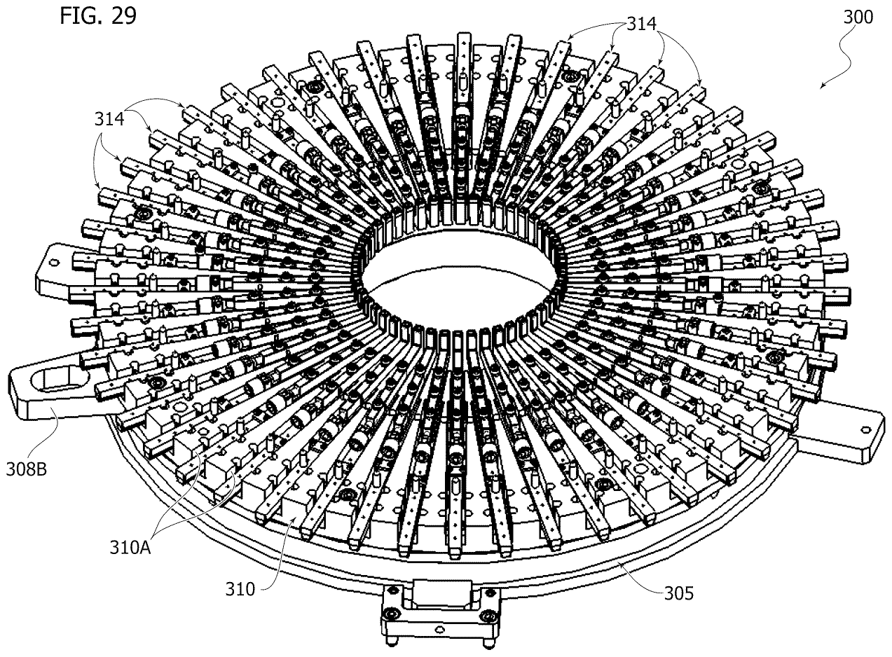

The flaring device 300 of the apparatus according to the invention will be described in the following with reference to FIGS. 6-9 and 29-34.

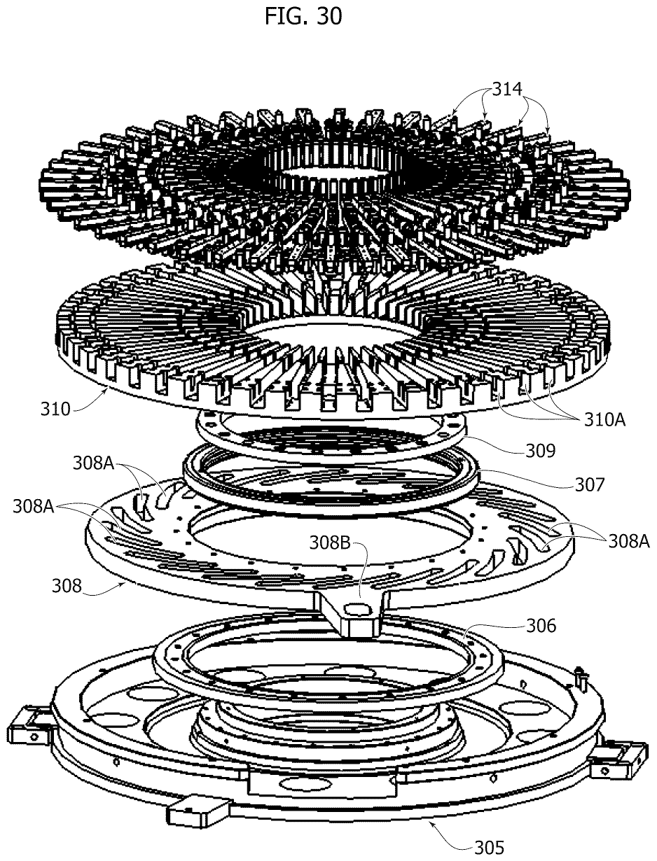

Referring in particular to FIGS. 7 and 30, the flaring apparatus 300 includes a driving annular plate 308 which is rotatably mounted between a lower annular plate 305 secured to the vertically movable plate 103, and an upper annular plate 310.

The upper annular plate 310 has an upper surface formed with a circumferential array of radial grooves 310A, within which a plurality of radial retractor elements 314 (one of which is shown at an enlarged scale in FIG. 32) are slidably mounted.

As better shown in FIG. 30, the driving annular plate 308 is rotatably mounted by means of an annular bearing 307 axially interposed between two rings 306 and 309.

The driving annular plate 308 is formed with a plurality of spiral slits 308A which are engaged by cam-followers 314A in the form of freely rotatable rollers, carried by the retractor elements 314 (see FIG. 32). In this manner, a rotation of the driving annular plate 308 around its axis causes a simultaneous radial movement of all the retractor elements 314 between a radial outer position and a radial inner position.

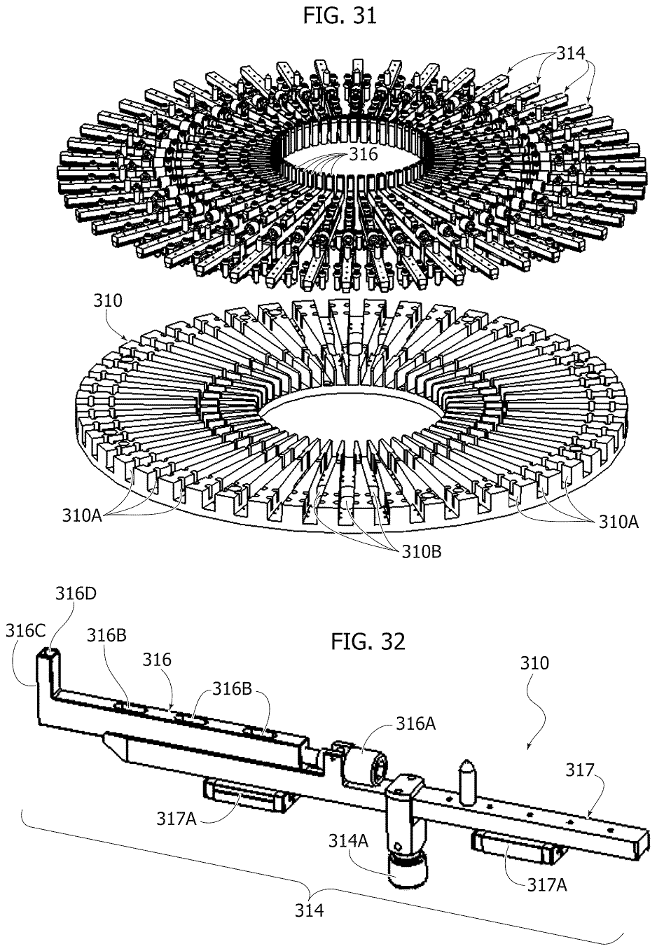

As better visible in FIG. 31, the upper annular plate 310, in which the grooves 310A are formed, has slots 310B through which the cam-followers 314A can project in order to engage the spiral slits 308A of the driving annular plate 308.

In the illustrated embodiment, each spiral slit 308 is engaged by two cam-followers 314A of two different retractor elements 314, so that the number of spiral slits 308 is half the number of the retractor elements 314.

Each spiral slit 308A can be formed according to a portion of an Archimedean spiral, so that a rotation of the driving annular plate 308 causes a radial movement with a constant velocity of the retractor elements 314.

As illustrated in FIG. 32, each retractor element 314 is composed, in the illustrated example, of a rod portion 316 and a support bar 317 on which the rod portion 316 is connected. The support bar 317 is provided with pads 317A for being slidably mounted within the respective groove 310A of the annular plate 310.

Also with reference to FIG. 32, in this example the radial position of the rod portion 316 relative to the support bar 317 can be adjusted, with the aid of a screw adjuster 316A. In any adjusted position the rod portion 316 can be secured to the support bar 317 by screws (not shown) engaged within slots 316B formed in the rod portion 316.

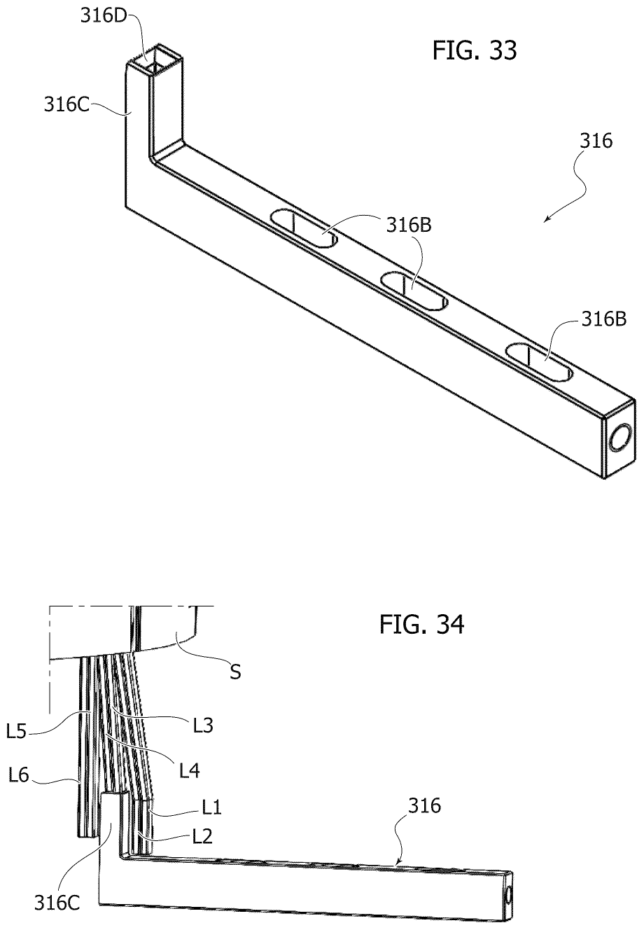

As better visible in FIG. 33, each rod portion 316 has a radially inner end with an upwardly projecting hollow hook portion 316C defining a cavity 316D within which one or more conductor L ends can be received, as a result of the raising movement of the vertically movable plate 103 (see FIG. 34).

The driving annular plate 308 has an outer projection 308B (FIG. 9) in which a slot is formed, which is engaged by a roller 304 (see also FIGS. 6 and 28) carried by the outer end of a crank 302 whose rotation is controlled by a servo-controlled electric motor 301, which is carried by the vertically movable plate 303.

When the vertically movable plate 103 is brought to a raised position, the radial retractor elements 314 of the flaring device 300 are in a radially inward position, such that specific conductor ends projecting from the stator can be received within the cavities 316D (FIGS. 33, 34) of the retractor elements 314. When the conductor ends have been received within the cavities 316D of the hook portions 316C of the retractor elements 314, the driving annular plate 308 can be rotated by activating the motor 301, so as to bring the retractor elements 314 in radially outward positions, so as to cause the engaged conductor ends to be moved away from the adjacent conductors, as will be explained in greater detail hereinafter, with reference to FIG. 35.

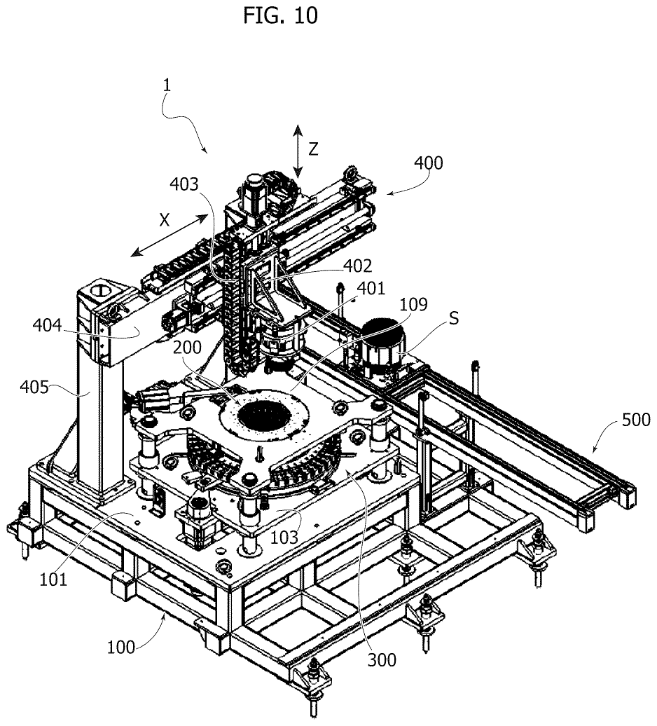

With reference to FIGS. 1 and 10, in the illustrated embodiment, a stator handling device 400 is associated with the flaring apparatus 1. The handling device 400 includes a handling head 401 carried by a slide 402 which is slidably mounted along at least one of a vertical direction (e.g., vertical axis) Z on a carriage 403 which is slidably mounted along a horizontal direction (e.g., horizontal axis) X on an elevated cross member 404, carried by the upper ends of two columns 405 secured to the base plate 101 of the support frame 100. The movements of the handling head 401 along directions X, Z, are driven by servo-controlled electric motors (not shown) in any known manner.

The handling head 401 is provided with a gripper 406, better shown in FIGS. 14, 15, by which the handling head 401 can transfer a stator S between an input/output position, for example at a conveyor 500 (see FIGS. 1 and 10) and the loading position on the flaring apparatus 1.

FIG. 13 shows the detail of a stator S being carried by the handling head 401. The handling head is provided with a bracket 401A, for being secured to the vertical slide 402 of the handling device 400.

The gripper 406 with which the handling head 401 is provided can be of any type. In the example of FIGS. 14, 15, an expansion gripper is provided, having three jaws 406A which can be moved between an inwardly retracted position (e.g., FIG. 14), in which they can be inserted through the central aperture of a stator S, and a radially expanded condition (FIG. 15) where they can engage the inner surface of the stator, to grip the stator.

The operation of the apparatus of the invention is described in the following.

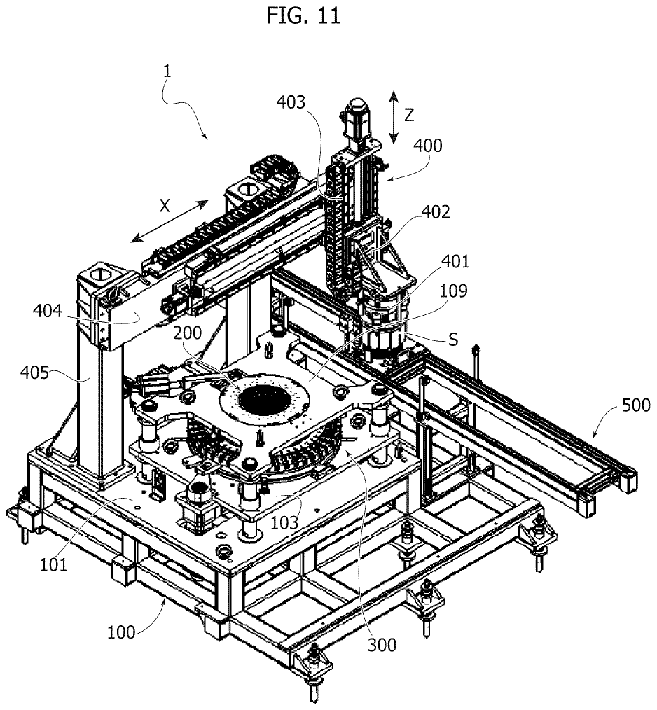

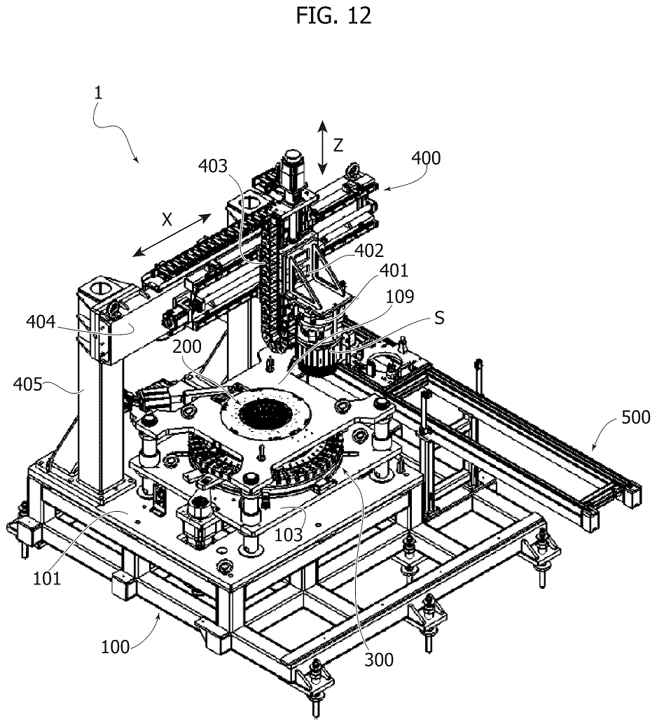

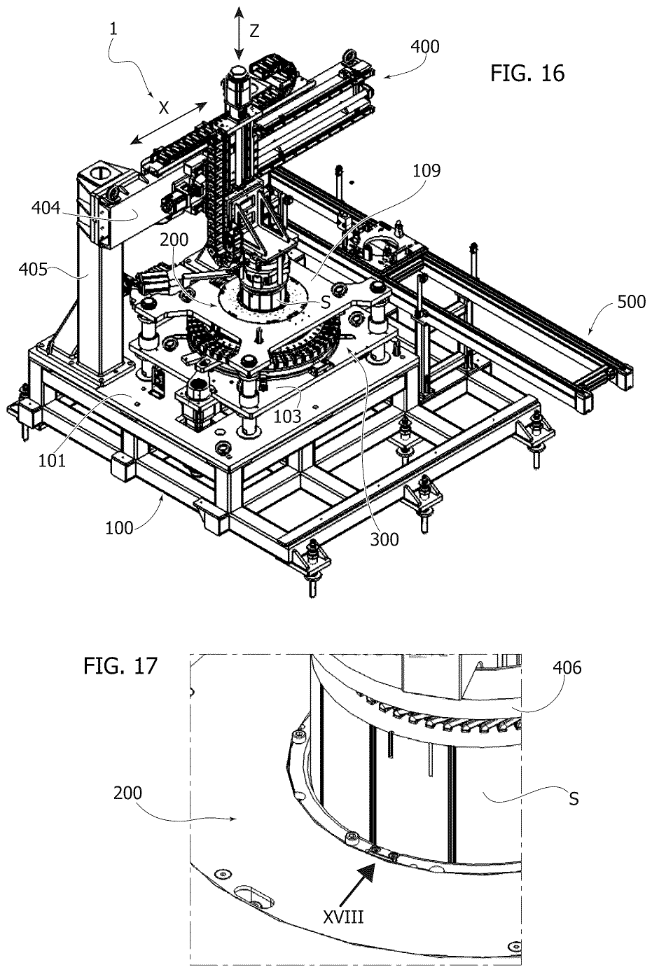

Referring to FIG. 10, when a stator S arrives at an input/output position on a conveyor 500 close to the flaring apparatus 1, the handling head 401 is moved so as to be positioned above the stator S and grip the stator, as shown in FIG. 11. Once a stator S has been gripped, the handling head can raise the stator (FIG. 12) and bring the stator on the flaring apparatus 1 as shown in FIGS. 16 and 17. In this condition, the angular position of the stator is precisely located by the engagement of the positioning key 205 within the cooperating cavity in the stator.

When the stator S has been received (e.g., unloaded) on the top plate 109 as shown in FIG. 16, the actuator 200A is activated (FIG. 19) to cause a rotation of the driving annular plate 202 of the insulating sheet protection device 200. In this manner, the array of radial protector elements 206 are moved from their radially outward position (FIGS. 22, 23) to their radially inward position (FIG. 24), in which the two portions 206A of the protector elements 206 are engaged within the insulating sheet portions P projecting from the stator so as to hold and protect these sheet portions P during the subsequent flaring operation.

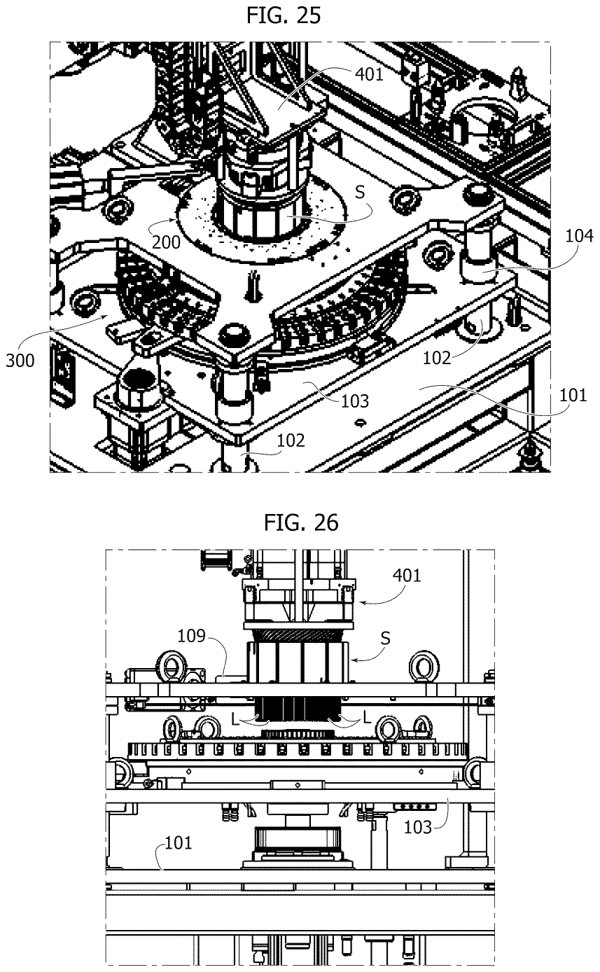

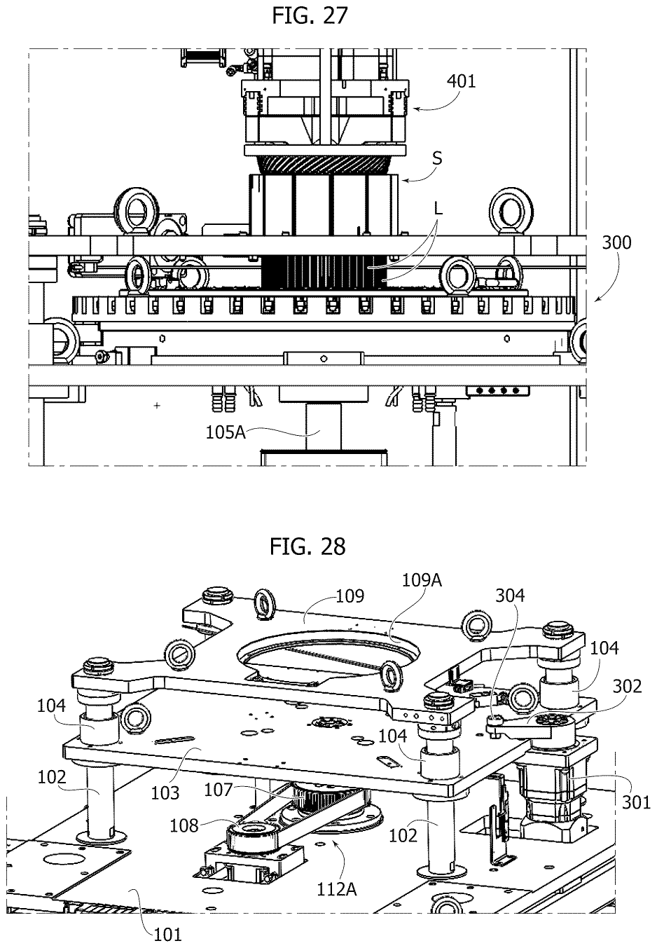

At this stage, the actuator 112 is activated to cause a raising movement of the vertically movable plate 103 from the lowered position shown in FIGS. 25, 26, to the raised position shown in FIG. 27.

When the vertically movable plate 103 has reached its raised position, the rod portions 316 of the retractor elements 314 are in a radial position such that a first pair (e.g., set) of conductors L1, L2 are received within the cavity 316D of the hook portion 316C of each rod portion 316 (see FIGS. 32-35).

In this condition, a rotation of the driving annular plate 308 of the flaring device 300 is caused by activating the electric motor 301 (see FIGS. 6, 25 and 28). In this manner, all the retractor elements 314 are caused to move to radially outward positions, so that the first pair of conductors L1, L2, projecting from each stator slot are caused to be spaced away from the adjacent conductors (e.g., flat wire conductors positioned adjacent thereto), as shown in FIG. 35(b).

At this stage, the vertically movable plate 103 is returned to its lowered position and the radial retractor elements 314 are moved to an inward radial position such that, when the vertically movable plate 103 is raised again, the ends of the second pair (e.g., set or further set) of conductors L3, LA projecting from each stator slot, is engaged by a respective radial retractor element 314. In this condition, the radial retractor elements 314 are again moved radially outwardly, so that for each stator slot the ends of the second pair of conductor ends L3, L4 are spaced from the ends of the adjacent third pair of conductors L5, L6 as shown in FIG. 35(c).

The vertically movable plate 103 can then be returned to its lowered position, leaving the conductor ends L1-L6 projecting from each stator slot in the condition shown in FIG. 35(d).

As clearly apparent form the foregoing description, the apparatus and method according to the invention provides various advantages. First of all, the invention enables the flaring operation to be carried-out rapidly and efficiently, while ensuring that no damage is brought to the sheet portions of insulating material projecting from the stator slots, thanks to the provision of the insulating sheet protection device as described above. Furthermore, the apparatus of the invention enables high productivity and at the same time high quality of the obtained product. The apparatus has a relatively simple and reliable structure which enables easy and quick maintenance operations. Moreover, the apparatus of the invention can be easily and rapidly adapted to operate on stators of different types. The vertical movements of the vertically movable plate 103, the radial movements of the protector elements 206 of the insulating sheet protection device 200 and the radial movements of the retractor elements 314 can be controlled by an electronic controller of the apparatus according to any given program, depending upon the characteristics of the stator, the configuration of the conductor ends projecting from the stator slots and the characteristics of the product to be obtained. Also, the configuration of the retractor elements 314 can be easily adjusted, by varying the relative position between the rod portion 316 and the support bar 317.

To increase productivity, more than one flaring apparatus 1 could operate in parallel, all the apparatus being served by one or more handling devices 400 of any known type.

Naturally, while the principle of the invention remains the same, the details of construction and the embodiments may widely vary with respect to what has been described purely by way of non-limiting example, without departing from the scope of the present invention, as defined in the appended claims.

1. An apparatus for flaring ends of flat wire conductors projecting axially outwardly from one end of a motor stator, said apparatus comprising:
a stationary support frame, configured for receiving and supporting the motor stator, the motor stator having a plurality of the flat wire conductors, inserted within inner slots of the motor stator, with an interposition of sheets of insulating material, said plurality of the flat wire conductors each having the ends projecting axially outwardly from the one end of the motor stator;
a vertically movable support structure, mounted on the stationary support frame,
a first driving device configured for controlling a vertical movement of the vertically movable support structure relative to the stationary support frame;
a flaring device, carried by said vertically movable support structure, and including a circumferential array of radially movable radial retractor elements configured for engaging respective of the ends of the flat wire conductors projecting axially outwardly from the one end of the motor stator and for retracting the engaged ends radially outwardly, so as to space them away from the ends of the flat wire conductors positioned adjacent thereto;
a second driving device configured for simultaneously controlling a radial movement of all the radial retractor elements of the flaring device between a radially inward position and a radially outward position;
an insulating sheet protection device carried by said stationary support frame and including a circumferential array of radially movable radial protector elements configured for engaging respective of portions of the sheets of the insulating material projecting axially outwardly from the one end of the motor stator, so as to prevent the engaged portions of the sheets of the insulating material from becoming damaged while said ends of the flat wire conductors are being retracted by said radial retractor elements of the flaring device; and
a third driving device for simultaneously controlling a radial movement of all the radial protector elements of the insulating sheet protection device between a radially inward position and a radially outward position.

2. The apparatus according to claim 1, wherein
said stationary support frame comprises a top plate defining a central aperture, the top plate configured to receive and support the motor stator having the flat wire conductors and portions of the sheets of the insulating material projecting axially outwardly from the one end of the motor stator;
said insulating sheet protection device being carried by said top plate, so that said circumferential array of radially movable radial protector elements surround the motor stator that is received within the central aperture of said top plate and are able to engage the respective of the portions of the sheets of the insulating material projecting axially outwardly from the one end of the motor stator,
said third driving device for the simultaneously controlling the radial movement of all the radial protector elements (206) of the insulating sheet protection device comprising:
a driving annular plate, rotatably mounted on said top plate around an axis of said central aperture of the top plate,
said driving annular plate of said third driving device having a plurality of spiral slits engaged by cam-followers which are carried by said radial protector elements, said plurality of spiral slits being configured so that a rotation of said driving annular plate of said third driving device between two end positions causes the radial movement of all said radial protector elements between said radially inward position and said radially outward position; and
an actuator of said third driving device configured for rotating said driving annular plate of said third driving device between said radially inward position and said radially outward position.

3. The apparatus according to claim 2, wherein said driving annular plate of the third driving device is rotatably mounted on a stationary annular plate carried by said top plate, said stationary annular plate having a plurality of radial grooves within which said radial protector elements are slidably guided.

4. The apparatus according to claim 2, wherein each radial protector element comprises a cam-follower of the cam-followers, wherein each spiral slit of said plurality of spiral slits is engaged by the cam-follower of two different of the radial protector elements, so that a number of the spiral slits is half a number of the radial protector elements.

5. The apparatus according to claim 1, wherein each radial protector element has a radially inner end configured to be introduced between two of the sheets of the insulating material projecting outwardly from two adjacent slots of the motor stator, so that each sheet of the insulating material is engaged on two sides by two different of the radial protector elements.

6. The apparatus according to claim 1, wherein
said stationary support frame comprises a top plate defining a central aperture, the top plate configured to receive and support the motor stator having the flat wire conductors and the sheets of the insulating material projecting axially outwardly from the one end of the motor stator;
said vertically movable support structure comprises a vertically movable plate which is slidably mounted below said top plate on guiding columns rigidly connecting said top plate to a base frame forming part of said stationary support frame;
said flaring device being carried by said vertically movable plate, so that when the vertically movable plate is in a raised position, said circumferential array of radially movable radial retractor elements surround the motor stator received within the central aperture of said top plate and are able to engage respective of the ends of the flat wire conductors projecting axially outwardly from the one end of the motor stator and to retract the engaged ends of the flat wire conductor radially outwardly, so as to space them away from the ends of the flat wire conductors positioned adjacent thereto;
said second driving device configured for simultaneously controlling the radial movement of all the radial retractor elements of the flaring device, the second driving device comprising:
a driving annular plate, rotatably mounted on said vertically movable plate around an axis of said central aperture of the top plate;
said driving annular plate of the second driving device having a plurality of spiral slits engaged by cam-followers which are carried by said radial retractor elements, said plurality of spiral slits being configured so that a rotation of said driving annular plate of said second driving device between two end positions causes the radial movement of said radial retractor elements between the radially inward position and the radially outward position, and
an actuator of the second driving device configured for rotating said driving annular plate of the second driving device between said radially inward position and said radially outward position.

7. The apparatus according to claim 6, wherein said driving annular plate of the second driving device is rotatably mounted between a lower annular plate carried by said vertically movable plate and an upper annular plate having a plurality of radial grooves within which said radial retractor elements are slidably guided.

8. The apparatus according to claim 6, wherein each radial retractor element comprises a cam-follower of the cam-followers, wherein each spiral slit of said plurality of spiral slits is engaged by the cam-follower of two different of the radial retractor elements, so that a number of spiral slits is half a number of the radial retractor elements.

9. The apparatus according to claim 7, wherein each radial retractor element comprises a rod portion having a radially inner end having an upwardly projecting hollow hook portion defining a cavity within which one or more of the ends of the flat wire conductors can be received.

10. The apparatus according to claim 9, wherein each radial retractor element includes said rod portion and a support bar to which the rod portion is rigidly connected, in a radially adjustable position, said support bar being slidably guided within a respective one of the plurality of radial grooves of said upper annular plate, and carrying a cam-follower of the cam-followers configured to engage a respective one of the spiral slits of said driving annular plate of the second driving device.

11. The apparatus according to claim 2, wherein said first driving device includes a screw rigidly connected to said top plate and engaged through a nut which is rotatably carried by said stationary support frame and driven by an actuating motor of the first driving device by a belt transmission.

12. The apparatus according to claim 1, comprising a handling head movable relative to said stationary support frame along at least one of a vertical axis or a horizontal axis and provided with a gripper for transferring the motor stator between a conveyor positioned adjacent the flaring apparatus and the flaring apparatus.

13. A method for flaring ends of flat wire conductors projecting axially outwardly from one end of a motor stator, said method comprising:
unloading the motor stator on a top plate forming part of a stationary support frame of a flaring apparatus, the motor stator having a plurality of the flat wire conductors inserted within inner slots of the motor stator with an interposition of sheets of insulating material, said flat wire conductors having the ends projecting axially outwardly from the one end of the motor stator;
providing a vertically movable support structure which is vertically movable relative to the stationary support frame below said top plate;
providing a flaring device carried by said vertically movable support structure and comprising a circumferential array of radially movable radial retractor elements which are configured for engaging respective of the ends of flat wire conductors projecting axially outwardly from the one end of the motor stator;
moving said vertically movable support structure from a lowered position to a raised position, wherein the radial retractor elements of the flaring device have been radially moved to a radial position such that in said raised position of the vertically movable support structure respective of the ends of the flat wire conductors are engaged by said radial retractor elements,
wherein after that the vertically movable support structure has reached its raised position, in which respective of the ends of the flat wire conductors are engaged by the radial retractor elements, moving the radial retractor elements radially outwardly, so that the ends of the flat wire conductors engaged by the radial retractor elements are spaced away from the ends of the flat wire conductors positioned adjacent thereto and projecting axially outwardly from the one end of the motor stator;
providing an insulating sheet protection device carried by said stationary support frame and including a circumferential array of radially movable radial protector elements configured for engaging respective of portions of sheets of insulating material projecting axially outwardly from the one end of the motor stator, and
simultaneously controlling a radial movement of all the radial protector elements of the insulating sheet protection device from a radially outward position to a radially inward position, in which the radial protector elements engage respective of the portions of the sheets of the insulating material projecting axially outwardly from the one end of the motor stator, so as to prevent the engaged portions of the sheets of the insulating material from becoming damaged while said ends of the flat wire conductors are being retracted by said radial retractor elements of the flaring device.

14. The method according to claim 13, comprising
after that the ends of a first set of the flat wire conductors have been spaced away from the ends of the flat wire conductors positioned adjacent thereto, the vertically movable structure is returned to the lowered position and the radial retractor elements are moved to a radial position such that in said raised position of the vertically movable support structure respective of the ends of a further set of the flat wire conductors are engaged by said radial retractor elements;
moving the vertically movable support structure to the raised position, so that respective of the ends of said further set of the flat wire conductors are engaged by the radial retractor elements, and
moving the radial retractor elements radially outwardly, so that said ends of said further set of flat wire conductors engaged by the radial retractor elements are spaced away from the ends of the flat wire conductors positioned adjacent thereto and projecting axially outwardly from the one end of the motor stator.

15. The method according to claim 13, wherein the motor stator is moved between said flaring apparatus and an adjacent conveyor, before and after a flaring operation on the motor stator, by a handling head movable relative to said stationary support frame along at least one of a vertical axis or a horizontal axis.
